(19) United States
(12) Patent Application Publication
(10) Pub. No.: US 2012/0191880 A1
(43) Pub. Date: Jul. 26, 2012

(54) SYSTEM AND METHOD FOR IDENTIFYING ACCESSORIES CONNECTED TO APPARATUS

(75) Inventors: Heer Gandhi, Pittsburgh, PA (US); Enrique Alfaro, Mars, PA (US); Sarjoun Skaff, Pittsburgh, PA (US); James Kong, Pittsburgh, PA (US)

(73) Assignee: Bossa Nova Robotics IP, Inc, Pittsburgh, PA (US)

(21) Appl. No.: 13/357,591

(22) Filed: Jan. 24, 2012

Related U.S. Application Data
(60) Provisional application No. 61/436,222, filed on Jan. 26, 2011.

(51) Int. Cl. G06F 13/14

(52) U.S. Cl. 710/16

(57) ABSTRACT

USB host controller and USB devices, associated methods and computer products are provide that addresses specifically the limitation of the USB standard for USB device controllers to support other devices on alternative interfaces. The implementation is applicable to most USB host controllers and USB devices, and is particularly applicable to a game system that includes an accessory having a communication port and an interactive apparatus having a communication port operable to mate with the communication port of the accessory. The interactive apparatus is operable to identify a type of accessory coupled to the communication port of the interactive apparatus.

### CROSS-REFERENCE TO RELATED APPLICATIONS

This application claims benefit of U.S. Provisional Patent Application Ser. No. 61/436,222, filed Jan. 26, 2011, which is herein incorporated by reference.

### BACKGROUND OF THE INVENTION

1. Field of the Invention

Embodiments described herein generally relate to communication between USB host controller and USB devices, and more specifically relate to interactive consumer electronics devices such as toys configured to communicate with accessories, along with methods for identifying accessories connected to said interactive consumer electronics devices.

2. Description of the Related Art

Consumer electronic devices, such as toys, may communicate with their accessories over many different communication protocols, one of which being Universal Serial Bus (USB). USB is an industry standard developed in the mid-1990s that defines the cables, connectors and protocols used for connection, communication and power supply between computers and electronic devices. The term computers today can now be extended to tablets, laptop computers and more generally any apparatus that has a USB host controller that can support USB devices.

USB is popular due to its widespread use and acceptance, along with its low implementation costs which make USB communication very attractive to consumer electronics, toys, and other industries. However, the USB standard limits an apparatus to be either a device or a host, in a master/slave interface. So, USB devices cannot be connected to each other directly without a host. For example, a camera with a USB device controller cannot support an USB flash drive and use its internal memory because they both are USB devices and thus cannot communicate per the USB standard. USB hosts controllers and device controllers are also relatively expensive in terms of components. USB On-the-Go is a newer standard that allows a USB device to communicate as a host but it is not an economical option for many low-cost devices, as it is expensive and cumbersome to implement. Therefore, just about all electronic toys communicate with their accessories in a master/slave relationship over a standard USB interface. This configuration prevents the toy from being a USB device to a host computer over the same USB interface. It is noteworthy that this problem is not limited to toys and accessories, but is generally applicable to many USB host controller and USB devices as well.

Therefore, there is a need to connect accessories to USB enabled devices at low cost to allow them to communicate. There is also a need for a simpler interface than USB to reduce electronic component costs on the accessory device.

Thus, there is a need for interactive toys configured to communicate with both accessories and other processors through a single communication port.

### SUMMARY OF THE INVENTION

Embodiments of the present invention generally relate to enabling communication USB host controller and USB devices, associated methods and computer products. In one embodiment, the present invention addresses specifically the limitation of the USB standard for USB device controllers to support other devices on alternative interfaces. In one embodiment, the present invention enables an apparatus equipped with a USB device controller to detect the type of accessory (i.e., a USB device) connected to a USB communication port of the apparatus. In another embodiment, the present invention enables an apparatus to function as a standard USB device controller when a host controller, such as a remote computer, is detected coupled to the communication port. In another embodiment, the present invention enables an apparatus to identify the type of accessory connected to its communication port as an accessory to the apparatus. In another embodiment, the present invention enables an apparatus to supply electric power to an accessory and thus effectively allows the apparatus to play the role of a host controller. In another embodiment, the present invention enables an apparatus to support an alternative communication interface on the USB port with an accessory outside of current USB protocols. Although the example of an apparatus having a USB host controller is described in the contact of an interactive toy and game system, the invention is applicable to any apparatus communicating with a USB device utilizing a USB port.

In one embodiment, a system is provided that includes an accessory having a communication port and an apparatus having a communication port operable to mate with the communication port of the accessory. The apparatus is operable to identify a type of accessory coupled to the communication port of the apparatus.

In another embodiment, a method of communicating is provided that includes mating communication ports of an apparatus and an accessory in a connector/receptacle relationship, and identifying a unique type of accessory coupled to the apparatus through a physical characteristic of the accessory.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 schematically illustrates one embodiment of a game system having at least an interactive apparatus and at least one associated accessory.

FIG. 2 is a schematic view of one embodiment of the accessory of FIG. 1.

FIG. 3 is a schematic view of one embodiment of the interactive apparatus of the game system of FIG. 1.

FIG. 4 is a schematic wire diagram of one embodiment of a communication port of an accessory coupled to a communication port of an interactive apparatus.

FIG. 5 is a schematic wire diagram of one embodiment of another communication port of an accessory coupled to a communication port of an interactive apparatus.

FIG. 6 is a schematic wire diagram of one embodiment of another communication port of an accessory coupled to a communication port of an interactive apparatus.

FIG. 7 is a flow diagram of one embodiment of a method for operating a game system.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

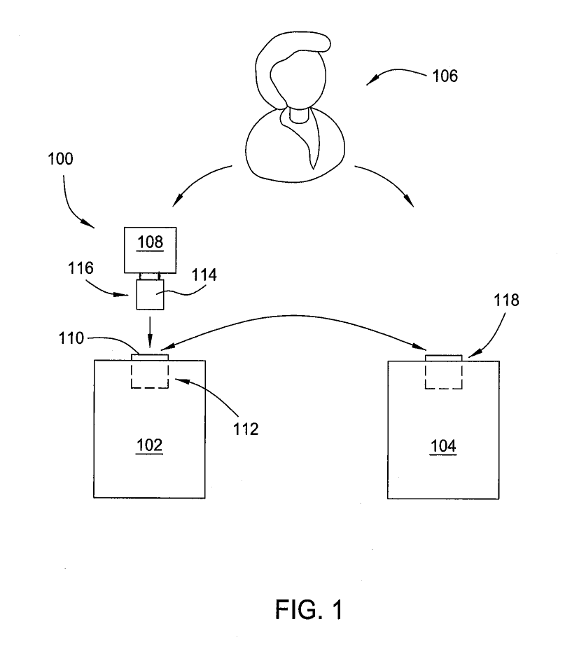

FIG. 1 illustrates one embodiment of a game system 100 having at least an interactive apparatus 102 and at least one associated USB device, i.e., an accessory 108, that communicate via communication systems 112, 116 having respective communication ports 110, 114. Although the invention is described as a game system having an interactive apparatus and at least one associated accessory, it is understood that the game system is representative of any system that includes an apparatus having a USB host controller communicating with a USB device (i.e., accessory) utilizing a USB port. The exemplary game system 100 may optionally further include an interactive application 104 associated with the interactive apparatus 102. The game system 100 may be configured for interactive entertainment, interactive companionship, interactive productivity, interactive utility and/or interactive learning.

The interactive application 104 includes a virtual avatar of the accessory 108 and interactive apparatus 102. At least one of the interactive apparatus 102, the accessory 108 and the interactive application 104 is configured to adapt from activities through the interactive experience of a user 106 with at least one of the other of the interactive apparatus 102, the accessory 108 and the interactive application 104, or through interaction of other users via their interactive apparatuses and/or the interactive applications (i.e., other game systems) with at least one of the interactive apparatus 102, the accessory 108 and the interactive application 104, including any on-line or off-line interaction with the accessory 108 or its virtual avatar. As the accessory 108 is in communication with the interactive apparatus 102 and the interactive application 104 through the interactive apparatus 102, at least one of the interactive apparatus 102 and the interactive application 104 may adapt from activities associated with the changes to at least one characteristic of the accessory 108, said changes occurring either in on-line or off-line play by the user 106.

The interactive application 104 is generally a software application that may be interacted with or played by the user 106 on a host computer. The host computer has a communication system 116 that enables exchange of data and/or signals with the communication system 112 of the interactive apparatus 102 may include a variety of systems, platforms, and architectures, including, but not limited to, computer systems, server systems, gaming consoles, mobile devices, cell phones, tablets, virtualized infrastructures, and cloud computing platforms. For example, the interactive application 104 may be a video game hosted on a gaming console or personal computer. In another example, the interactive application 104 may be a video game application executed on a remote server accessible via a network such as the Internet. One embodiment of an interactive application 104 is more completely described in U.S. patent application Ser. No. ______, filed ______, which claims priority to U.S. Patent Application Ser. No. 61/435,794, filed Jan. 25, 2011, both of which are incorporated by reference in their entireties.

The interactive apparatus 102 may be used with or without (i.e., independent of) the accessory 108. The associated accessory 108 is a device that enhances a user's interactive experience with the interactive apparatus 102. The interactive experience may be one of entertainment, learning or companionship. As discussed above, both the interactive apparatus 102 and the accessory 108 include a communication port 110, 114, such as a standard USB port, which allows communication between the interactive apparatus 102 and the accessory 108. Particularly, the communication port 110 of the interactive apparatus 102 is configured to provide one or more of the following functions while still enabling the interactive apparatus 102 to function as a USB device when coupled to a USB host computer: (1) allow the interactive apparatus 102 to identify that the particular accessory 108 (as opposed to a host computer) is coupled to the communication port 110; (2) allow the identity of the particular accessory 108 to be determined by the interactive apparatus 102; (3) allow the interactive apparatus 102 to function as a USB host controller relative to the accessory 108; (4) allow data transfer between the accessory 108 and the interactive apparatus 102; and (5) provide power to the accessory 108 from the interactive apparatus 102. The details of the method and apparatus that enable communication between the interactive apparatus 102 and the accessory 108 and/or providing of power to the accessory 108 by the interactive apparatus 102 are detailed further below.

The communication ports 110, 114 are strengthened such that when accessory 108 mates with the interactive apparatus 102, the physical connection provides sufficient structural strength so the combination of the interactive apparatus 102 and accessory 108 can be viewed as an integrated whole. In particular, the combined interactive apparatus 102 and accessory 108 can pass safety and quality tests, some mandated by legal authorities to authorize product commercialization, and typically applied separately to individual accessories and apparatus. In one embodiment, the communication port 110 of the interactive apparatus 102 may be configured as a female USB receptacle while the communication port 114 of the accessory 108 may be configured as a male UBS plug, or vice versa. In this manner, the male communication port 114 of the accessory 108 may be inserted into the female communication port 110 of the interactive apparatus 102 to securely couple the accessory 108 to the interactive apparatus 102 without further need for additional connections or fastening.

The interactive apparatus 102 is generally an object configured for entertaining or educating the user 106 through the user's interaction with the interactive apparatus 102, or for providing companionship for the user 106. The interactive apparatus 102 may be, but is not limited to, consumer electronics device, for example toys such as robots, vehicles, aircraft, play sets, dolls and board games.

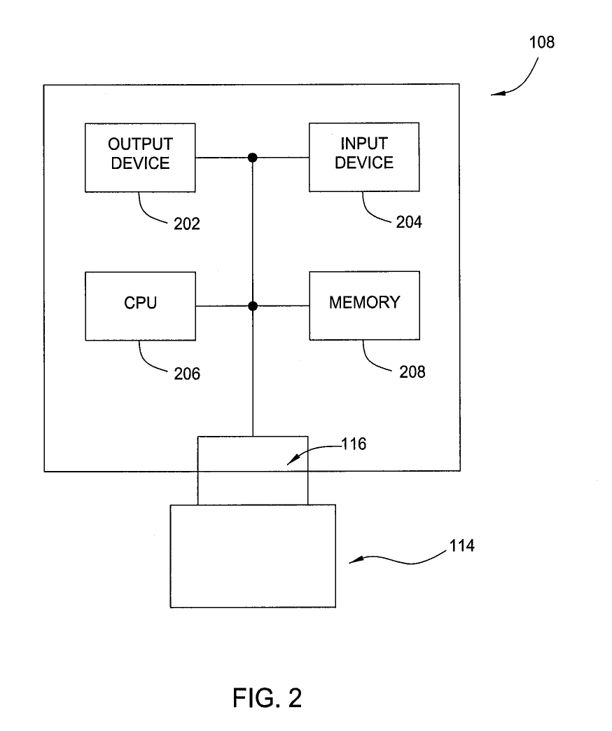

FIG. 2 is a more detailed view of one embodiment of the accessory 108 of FIG. 1. The accessory 108 is powered through and/or communicates with the interactive apparatus 102 through the communication port 114 of the accessory 108 when coupled to the communication port 110 disposed on the interactive apparatus 102. The accessory 108 may include at least one output device 202 along with the communication port 114 and/or the accessory may exist with only a resistor having a predefined resistance so that the accessory 108 simply acts as key that unlocks functionality of the apparatus 102 associated with the predefined resistance when the accessory 108 is detected by the apparatus 102. The accessory 108 may also include at least one input device 204, central processing unit (CPU) 206, memory 208, and power source 212. The power source 212 may be a battery, solar cell or other accessory on-board power providing device. Optionally, power may be provided to the communication port 114 of the accessory 108 from the interactive apparatus 102 through the communication port 110 of the interactive apparatus as described further below.

The one or more output devices 202 of the accessory 108 are configured to enhance the user's interactive experience with the interactive apparatus 102. The output device 202 may be activated by an input signal provided from the environment external to the accessory 108, in response to a signal received from the interactive apparatus 102 through the communication port 114, and/or signal received from the input device 204 of the accessory 108. Examples of output devices 202 include sound generating devices (e.g., speakers, buzzers, vibrators, sound effect generator and the like), light generating devices (e.g., lasers, LED, display panels, visual effect generator and the like), and actuators (e.g., motors, solenoids, and the like), projectile launchers, or external communication signal generator (e.g., wireless signal generator, RF signal generator, optical signal generator, and the like). For example, the accessory 108 may include an output device 202 in the form of a light cannon. The light cannon, in response in an input signal, may generate a beam of light indicative of a laser weapon possessed by the interactive apparatus 102. In another example, the accessory 108 may include an output device 202 in the form of tracking device. The tracking device, in response to an input signal, may provide information indicative of a location of an object or indicate a desired direction to the interactive apparatus 102. In another example, the accessory 108 may include an output device 202 in the form of a communication signal generator. The external signal generator, in response to an input signal, may generate a signal enabling peer-to-peer communication with other similar interactive apparatuses and/or accessories mounted on other interactive apparatuses within the communication range of the interactive apparatus 102 to which the accessory 108 is affixed. In another example, the accessory 108 may include an output device 202 in the form of a launcher that fire make-believe projectiles at some target or other apparatuses.

The input device 204 may be a signal generating device, such as a button, switch, sensor and the like, configured to provide an input signal to at least one of the output devices 202, the interactive apparatus 102 or other interactive apparatuses within communication range of the interactive apparatus 102 to which the accessory 108 is affixed. For example, the input device 204 may be gyroscopes, accelerometers, proximity-sensors, light sensors, infrared sensors, a wireless connectivity sensor, such as a radio frequency (RF) sensor, that enables peer-to-peer communication with other similar accessories 108, provides information relating to the motion of the interactive apparatus 102 to which the accessory 108 is affixed, and/or information relating to the external environment proximate to the accessory 108, such as the proximity of a wall, obstacle, or another interactive apparatus, such as communicating with another interactive apparatus during an interactive game, such as laser tag. In another example, the accessory 108 may include an input device 204 in the form of a button or switch. The button or switch may be actuated to provide an input signal received by the output device 202 of the accessory 108 or the interactive apparatus 102, either directly or through the CPU 206. The input signal may, for example, cause the output device 202 to generate a visual or sound effect, create motion, or generate a communication signal receivable by the interactive apparatus 102 or another interactive apparatus accessory. In another example, the input signal may pass from the accessory 108 via the communication port 114 to the communication port 110 of the interactive apparatus 102 which may cause the interactive apparatus 102 to generate its own visual effect, audio effect or actuate the actuators of the interactive apparatus 102 to provide motion.

In embodiments wherein the accessory 108 includes the CPU 206 and memory 208, the CPU 206 may be used to retrieve and execute programming instructions stored in the memory 208. The instructions may be provided to the memory 208 through the communication port 110 from the interactive apparatus 102, or received by the input device 204 from another interactive application or nearby accessory. The CPU 206 stores and retrieves application data residing in the memory 208. In one embodiment, the CPU 206 is configured to enable writing, erasing, and re-writing of programming instructions and computer code received by the accessory 108 and stored in the memory 208. The CPU 206 controls the function of the output device 202 in response to receiving an input signal, for example, from the input device 204, interactive apparatus 102 or from an interactive apparatus and/or other accessory in communication with the interactive apparatus 102 to which the accessory 108 is affixed. The CPU 206 is intended to include basic processing devices, such as a state machine and the like.

The memory 208 may be any suitable form of digital storage. For example, the memory 208 may be a random access memory (RAM), a read-only memory (ROM), an erasable programmable read-only memory (EPROM, Flash memory, FRAM, PCM and other suitable digital storage device), an optical storage device, a magnetic storage device, any suitable combination of the foregoing or other suitable electronic storage medium.

The memory 208 may store instructions controlling the function of the accessory 108, and function of the output devices 202 of the accessory 108, along with data indicative of the operation of the accessory 108, for example, the operation of the input devices 204 and output devices 202. The stored information, sometimes referred to as “metrics”, may be stored as one or more event records within memory 208. Each of the metrics may be recorded as separate events, or may be recorded in aggregate as a single general event. The event records within memory 208 may contain metrics information about the history of actuation of the output devices 202, input signals, sensor data from the input devices 204, apparatus state 222 of the accessory (e.g., accessory “power” and “status”), and information data received from one or more other accessories or other interactive apparatuses (either controlled by the user or another person) which have communicated with the accessory 108. The accessory 108 may transmit the event records containing information (e.g., about the accessory's) apparatus state 222, or information data received from one or more other apparatuses/accessories in communication with accessory 108 coupled to the interactive apparatus 102 via the communication ports 110, 114 to the interactive application 102 and/or ultimately to the interactive application 104, as described below.

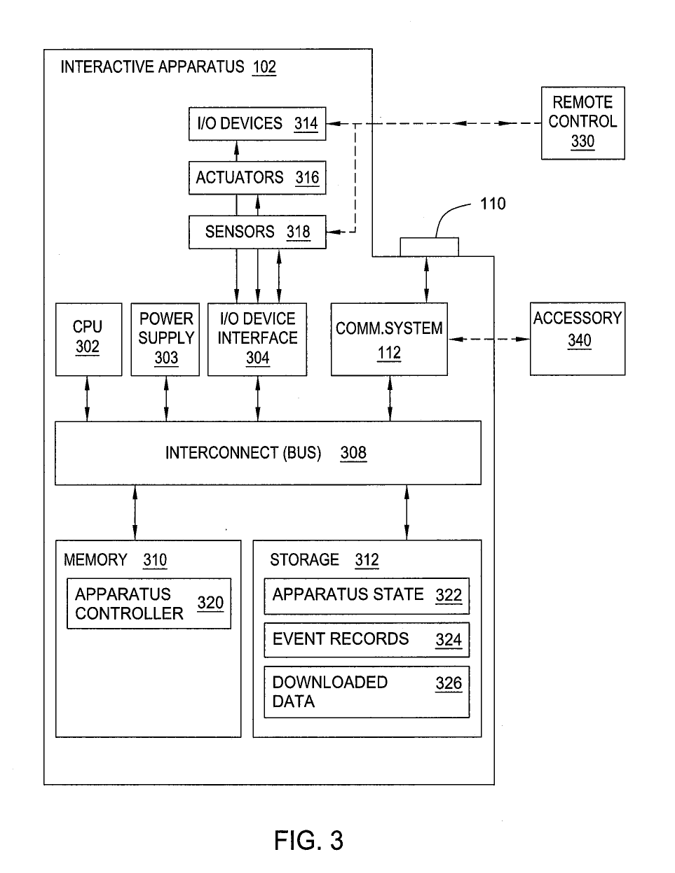

FIG. 3 is a more detailed schematic view of the interactive apparatus 102 of FIG. 1, according to one embodiment of the invention. As shown, the interactive apparatus 102 includes, without limitation, a central processing unit (CPU) 302, an I/O device interface 304, the communication system 112 coupled to the communication port 110, a power supply 306, an interconnect (bus) 308, a memory 310, storage 312, and one or more I/O devices 314.

The power supply 306 may be a battery, solar cell or other power providing device on-board the interactive apparatus 102. The power supply 306 is utilized to power the component of the interactive apparatus 102, such as the CPU 302 and the one or more I/O devices 314, and in certain embodiments, powering the accessory 108.

The CPU 302 retrieves and executes programming instructions stored in the memory 310. Similarly, the CPU 302 stores and retrieves application data residing in the memory 310. The CPU 302 is configured as a USB device controller to control the function of and/or communication with the accessory 108, and is configured to allow communication with the communication system 116 of a host computer (not shown) that can be coupled to the communication port 110 of the interactive apparatus 102. The interconnect 308 is used to transmit programming instructions and application data between the CPU 302, I/O devices interface 314, storage 312, communication system 112, and memory 310. CPU 302 is included to be representative of a single CPU, multiple CPUs, a single CPU having multiple processing cores, and the like. In one embodiment, the CPU 302, memory 310, and storage 312 are configured to enable writing, modifying, erasing, and re-writing of programming instructions and computer code received from the interactive application 104, and/or provided to the accessory 108 from the interactive apparatus 102. The memory 310 is generally representative of a random access memory or other suitable digital storage device. Storage 312, such as a hard disk drive or flash memory storage drive, may store non-volatile data. It is contemplated that the memory 310 and storage 312 may take other forms.

The communication system 112 is configured to allow for a bidirectional exchange of information data through the communication port 110 from the interactive apparatus 102 to the accessory 108, and from the accessory 108 to the interactive apparatus 102. The communication system 112 may also be configured to allow for a bidirectional exchange of information data from the interactive apparatus 102 to the interactive application 104, and from the interactive application 104 to the interactive apparatus 102. Communication by the communication system 112 may take place in one or more modalities, including but not limited to, physical contact, wired connection, and wireless connection when communicating with the interactive application 104 and/or other interactive apparatus, or through the communication port 110 when communicating with the accessory 108. Operation of the communication system 112 is described later in further detail.

The one or more I/O devices 314 are connected via the I/O device interface 304 to the CPU 302 and configured to interact with the environment external to the interactive apparatus 102. Examples of I/O devices 314 include means for information output, such as audio visual devices (e.g., display panels, light emitting diodes, audio speakers), and user input interfaces (e.g., buttons, wired or wireless controllers). Other devices of the interactive apparatus 102 include actuators 316 (e.g. motors), sensors 318 (e.g., proximity-sensors, light sensors, infrared sensors, gyroscopes, accelerometers), and peripheral devices (e.g., accessories). In one embodiment, the sensors 318 may include a wireless connectivity sensor, such as a radio frequency (RF) sensor, that enables peer-to-peer communication with other similar interactive apparatuses 102. The interactive apparatus 102 may further include circuitry and electronics configured to support the operation and to interpret data acquired from the I/O devices 314, actuators 316, and sensors 318.

The user 106 may interact with the interactive apparatus 102 through one or more of the I/O devices 314, sensors 318 and communication system 112. For example, the user 106 may interact with the interactive apparatus 102 through one or more of the I/O devices 314 in the form of switches, buttons and levers, cameras, microphones among other input devices. The I/O devices 314 may also be configured to communicate with a remote controller 330. The remote controller 330 may be a hand-held controller, a cell phone, smart phone, tablet computer or other mobile or non-mobile device. The communication between the remote controller 330 and the I/O devices 314 may be wired or wireless. In another example, the user 106 may interact with the interactive apparatus 102 through sensors 318 which generate a signal provided to the CPU 302 in response to the user's touch, sound or voice, and/or stimuli provided by interaction of the interactive apparatus 102 with other interactive apparatus and/or real world objects, such as sounds, force and obstacles, among others, including communication with other interactive apparatuses. In another example, the user 106 may interact with the accessory 108 and/or the interactive apparatus 102 through the communication system 316 as further described below.

The memory 310 includes an apparatus controller 320 configured to control operations of the interactive apparatus 102 and provide one or more modes of interaction with the user 106. The apparatus controller 320 expresses behavior and physical attributes of the interactive apparatus 102 via the I/O devices 314, actuators 316, and sensors 318. The apparatus controller 320 may also express the behavior and physical attributes of the interactive apparatus 102 via the output devices 202 of the accessory 108. For example, the apparatus controller 320 may control movements of the interactive apparatus 102 using the actuators 316 to articulate arms or rotate wheels. In another example, the apparatus controller 320 may utilize the audio-visual I/O devices 314 to emit one or more audio-visual signals, such as lights and/or sounds.

The apparatus controller 320 may also express the behavior and physical attributes of the interactive apparatus 102 via the output devices 202 of the accessory 108. For example, the apparatus controller 320 may control lights, sounds, motions and other outputs of the output devices 202 of the accessory 108 coupled to the interactive apparatus 102, thereby enhancing the user's experience with the interactive apparatus 102.

The apparatus controller 320 maintains a logical state of the interactive apparatus 102, referred to herein as an apparatus state 322, within storage 312. The apparatus state 322 may represent one or more virtual attributes of the interactive apparatus 102, and optionally, the virtual attributions of the accessory 108. Examples of virtual attributes that comprise the apparatus state 322 include, but are not limited to, one or more of health, strength, stamina, money, points, experience, special power, and mood. In one implementation, the apparatus state 322 may be quantitatively expressed as one or more numerical values, Boolean values, and other known value systems, etc. The apparatus state 322 may further represent an “inventory” of qualities, attributes, and/or objects possessed by the interactive apparatus 102. Examples of objects within the inventory of the interactive apparatus 102 include, but are not limited to, awards, achievements, completed objectives, weapons, tools, money, magic and abilities. The apparatus state 322 may include one or more pre-defined behaviors for operating the interactive apparatus 102, such as pre-defined sequences of movements, lights, and/or sound.

In one embodiment, the apparatus controller 320 may utilize the apparatus state 322 to determine the operation of the interactive apparatus 102. Based on the apparatus state 322, the apparatus controller 320 may enable or disable behavior, routines, and/or capabilities of the interactive apparatus 102. Further, the apparatus controller 320 is configured to modify the apparatus state 322 based one or more interactions with the user 106, the accessory 108, other interactive apparatuses/accessories, and/or based on information received from the interactive application 104, as described later.

The apparatus controller 320 generates information data responsive to the user 106 interacting with the interactive apparatus 102 using at least one of the I/O devices 314, actuators 316, sensors 318 and accessory 108. For example, the apparatus controller 320 may generate input data in response to a command from the user 106 via an I/O device 314, such as a remote controller, button press or voice command. In another example, the apparatus controller 320 may generate sensor data from the sensors 318 in response to stimulus external to the interactive apparatus 102, such as picking up, orientating, and/or squeezing the interactive apparatus 102. In yet another embodiment, the apparatus controller 320 may generate accessory data from the accessory 108 in response to the function of the accessory 108 coupled to the interactive apparatus 102, such as actuating the input devices 204, outputs of the output devices 202, and communication with other interactive apparatuses through the accessory 108. The generated data, sometimes referred to as “metrics”, may be stored as one or more event records 324 within storage 312. Each of the metrics may be recorded as separate events in the event records 324, or may be recorded in aggregate as a single general event.

The apparatus controller 320 is configured to modify the apparatus state 322 based on interactions with the user 106. As defined herein, the phrase “interactions with the user” is intended to include at least one or more of one or more commands and/or signals from the accessory 108 and the I/O device 314, engagement with a second interactive apparatus, engagement with a second accessory not coupled to the accessory 108, interaction of the interactive apparatus 102 with its surrounding environment as detected by the sensor 318, or a particular user input responsive to an output of the interactive apparatus 102. The apparatus controller 320 is configured to determine a change in the apparatus state 322 based on one or more interactions with the user 106. In one embodiment, the apparatus controller 320 may modify the apparatus state 322 within storage 312. The apparatus controller 320 may further store the change in the apparatus state 322 as one or more event records 324 within storage 312.

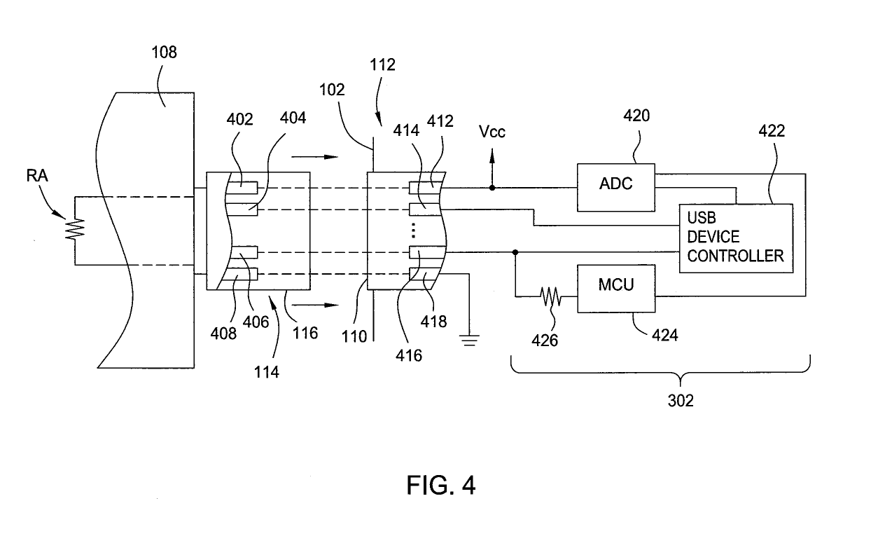

FIG. 4 is a schematic wire diagram of the communication port 114 of the accessory 108 coupled to the communication port 110 of the interactive apparatus 102. As the communication ports 110, 114 are of standard USB construction, each port has 4 mating pins (5 in the case of a Mini-USB construction). The interactive apparatus 102 and accessory 108 are shown spaced-apart to allow viewing of pins 402, 404, 406, 408 of the accessory 108 and pins 412, 414, 416, 418 of the interactive apparatus 102. Pins 402, 412 correspond to PIN 1 (VCC) of a standard USB plug/receptacle, pins 404, 414 correspond to PIN 2 (D−) of a standard USB plug/receptacle, pins 406, 416 correspond to PIN 3 (D+) of a standard USB plug/receptacle, while pins 408, 418 correspond to PIN 4 (ground) of a standard USB plug/receptacle.

Each type of accessory 108 has a predefined electrical characteristic which may be utilized to identify the accessory 108 though determining the characteristic through the communication port 114 of the accessory 108. The predefined characteristic may be an electrical characteristic, such as resistance. In one embodiment, each type of accessory 108 has a unique resistance measured across pins 402, 408 which may be utilized to identify the type of accessory 108 by the resistance itself or of a metric of an electrical signal pass across the resistance. For example, a first predefined range of electrical characteristics may be indicative of a first type of accessory 108, while a second predefined range of electrical characteristics may be indicative of a second type of accessory 108. It is contemplated that there may be more than two predefined ranges. Certain predefined ranges may be indicative that a host computer hosting the interactive application 104 (as opposed to an accessory 108) is coupled to the interactive apparatus 102, which in this case the interactive apparatus 102 would be configured to communicate with the host computer using standard USB protocols or other suitable communication methodology. A look-up table corresponding to the different predefined ranges may be stored in the memory 310 of the interactive apparatus 102 to facilitate identification of the accessory 108.

In one embodiment, the interactive apparatus 102 includes an Analog to Digital Converter (ADC) 420, a USB device controller 422, and a Micro-Controller (MCU) 424 onboard the interactive apparatus 102. The MCU 424 may be a standard low-cost micro-controller to minimize costs. The ADC 420, USB device controller 422 and the MCU 424, shown separately in FIG. 4, would reside in at least one of the CPU 302 and memory 310 of the interactive apparatus 102, or other suitable location within the interactive apparatus 102 and in communication with the communication port 110. The interactive apparatus 102 detects and identifies the host or an accessory 108 connected to the commutation port 110 of the interactive apparatus 102 using the ADC 420 and a software quantization algorithm running on the MCU 424 onboard the interactive apparatus 102.

In one embodiment, the ADC 420 continuously samples the voltage on pin 412 of the communication port 110 and transfers that information to the MCU 424. This voltage information may be quantized in a digital binary format. The MCU 424 down-samples the voltage information data to categories of accessories 108 based on the voltage set by the accessory 108 on the pin 412 due to the predefined internal resistance of accessory 108. The down sampling of the information is tolerant to component variations in the interactive apparatus 102 and on the accessory 108. When a USB host controller like the one in a host computer accessing the interactive application 104 is connected to the communication port 110 of the interactive apparatus 102, the ADC 420 detects and measures a voltage on pin 412 supplied by the host computer and transfers its digital equivalent to the MCU 424. The MCU 424 will power up the USB Device Controller 422 of the interactive apparatus 102 and have it communicate normally with the host computer utilizing a standard USB or other suitable communication protocol. The predefined voltage ranges are chosen appropriately to account for variations in the interactive apparatus 102, the sampling and measurement of the ADC 420, the voltage supplied by the host controller, etc., to accurately enable identification of the accessory 108. It is beneficial for the typical voltage level detected in response to the predefined resistance of an accessory 108 to fall in the center of the predefined range, thus allowing for greater tolerance in component variation and reliable identification of the accessory type.

The accessory 108 may also be identified based on a voltage that they present on pin 412 that is measured by the ADC 420. To achieve this, a known reference voltage from a reference voltage source (not shown) disposed in the interactive apparatus 102 is applied to the pin 412 through a weak pull-up resistor. When neither the accessory 108 nor host computer is attached to the communication port 110, the voltage measured by the ADC 420 will be that of the reference voltage. When a host computer is coupled to the communication port 110, the host computer drives the voltage on pin 412 to a predefined voltage, for example 5 Volts or 3.3 Volts, thus overriding the reference voltage set on the pin 412 by the interactive apparatus 102.

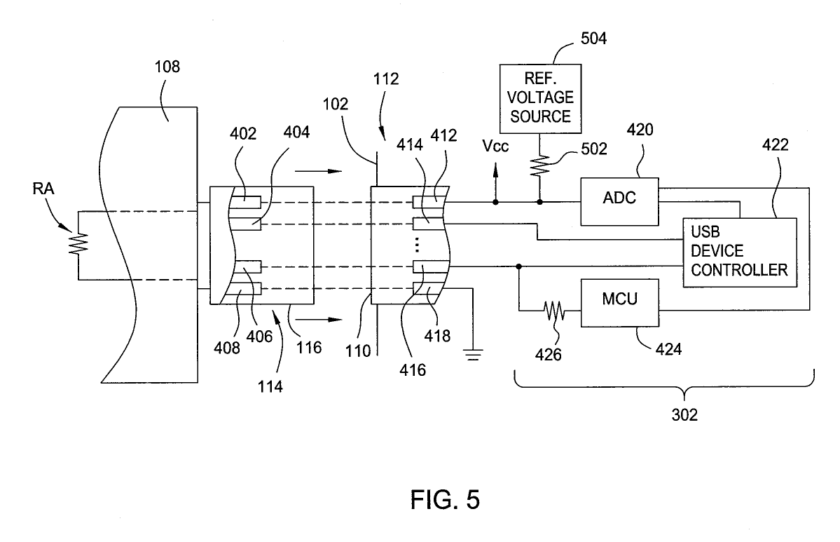

FIG. 5 depicts another schematic wire diagram of an accessory 108 having a communication port 114 coupled to a communication port 110 of an interactive apparatus 102. RA is a unique resistance attached in the accessory 108 between pin 402 and pin 408. The resistance RA will create a voltage VCCA on pin 412 which is measured by the ADC 420. The voltage measured by the ADC 420 based on the RA resistance in the accessory 108 may be expressed by:
VCCA=REF_VOLTAGE*RA/(RA+R2) where R2 is resistance of a weak pull-up resistor 502 that hooks a reference voltage source 504 to pin 412.

The VCCA voltage measured by ADC 420 is utilized to identify the specific type of accessory 108 coupled to the interactive apparatus 102. The values of the VCCA voltage associated with each type of accessory 108 may reside in a look-up table stored in the memory 310 and/or storage 312 of the interactive apparatus 102. In addition, using the above methodology, the interactive apparatus 102, in addition to being able to function as a USB host controller for an accessory 108 coupled thereto, is able to identify a host computer such as PC, tablet or other device having a USB controller, and function as a USB device under the command of the host computer.

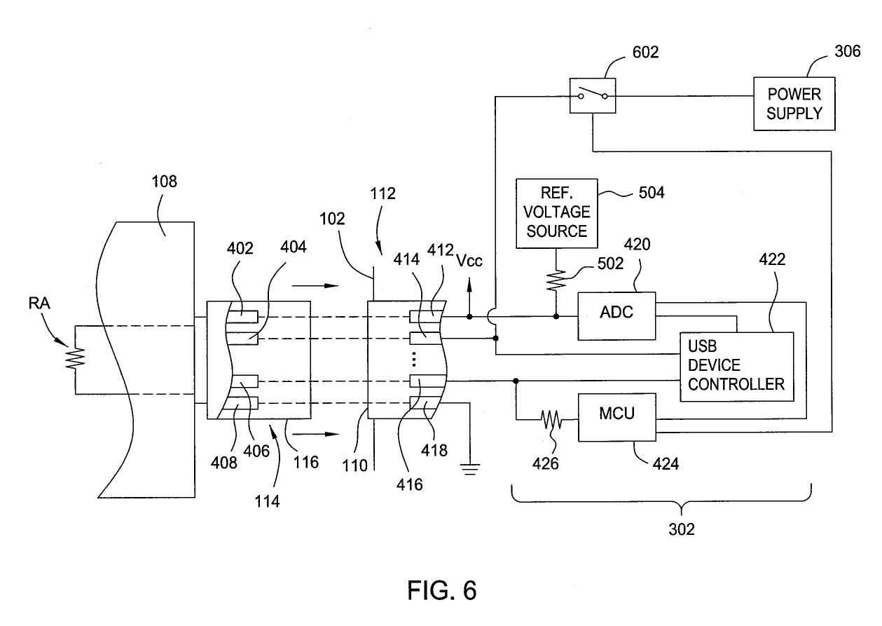

FIG. 6 depicts another schematic wire diagram of an accessory 108 having a communication port 114 coupled to a communication port 110 of an interactive apparatus 102 in which the interactive apparatus 102 is configured to provide power to the accessory 108 to run the one or more output devices 202. The accessory 108 in this embodiment would benefit by not having to have an on-board power source, thus reducing the cost of the accessory 108 and eliminating the need for additional batteries.

In the embodiment of FIG. 6, the interactive apparatus 102 is configured similar to as shown in FIG. 5, and is able to detect an accessory 108 coupled to the communication port 110 in a similar fashion. Upon the interactive apparatus 102 detecting the accessory 108 coupled thereto, the MCU 424 disables the USB device controller 422. With the USB device controller 422 disabled, pins 404, 414 and 406, 416 are free to operate as an alternative communication interface. In the embodiment of FIG. 6, pins 404, 414 may be used to power the accessory 108 through the power supply 306 of the interactive apparatus 102. To provide power to the pin 414, the MCU 424 controls a semiconductor switch 602 that connects pin 414 to the power supply 306 of the interactive apparatus 102. The semiconductor switch 602 is turned off by the MCU 424 when neither an accessory 108 nor a host computer is detected on the communication port 110. When an accessory 108 is detected, the MCU 424 disables the USB device controller 422 and turns on the semiconductor switch 602 to supply power to the accessory 108 via pins 404, 414, as shown in FIG. 6. This enables the power supply 306 of the interactive apparatus 102 to power an output device 202 (and/or CPU 206) of the accessory 108. When a host computer is detected as coupled to the communication port 110, the semiconductor switch 602 remains off and the USB device controller 422 is enabled such that the host computer and interactive apparatus 102 may communicate using a standard USB protocol. It is also contemplated that power may be transferred over a different pair of pins, such as pins 406, 416.

Accessories 108 that are equipped with their own CPU 206 can use pin 406 of the communication port 114 for communicating with the MCU 424 of the interactive apparatus 102 via pin 416 of the communication port 110. Thus, communication between the interactive apparatus 102 and accessory 108 over the pair of pins 406, 416 is configured as a single-wire communication interface. For data or information transfer between the accessory 108 and the interactive apparatus 102, an asynchronous serial protocol is employed over pins 406, 416. The serial protocol is asynchronous as no free lines for sharing a clock are available for synchronizing communication. The serial protocol over the interface defined across pins 406, 416 may have a master-slave arrangement between the accessory 108 and the interactive apparatus 102 so that at any one time only one of them are driving across the pins 406, 416. It is also contemplated that a single-wire communication interface may be established over a different pair of pins, such as pins 404, 414.

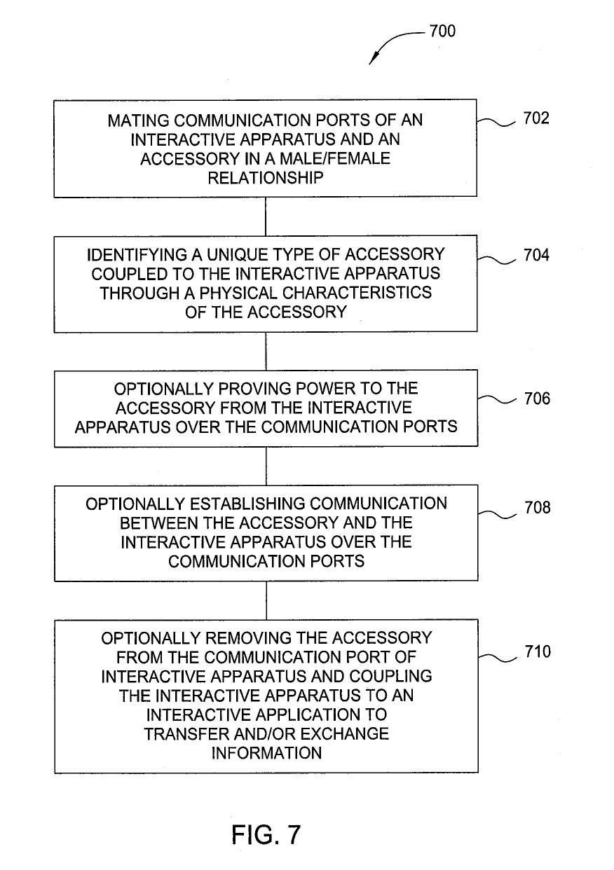

FIG. 7 is a flow diagram of one embodiment of a method 700 for operating the game system 100. The method begins at step 702 by mating the communication ports 110, 114 of the interactive apparatus 102 and the accessory 108 in a male/female relationship. A step 704, the interactive apparatus 102 identifies the unique type of accessory 108 coupled thereto through the physical characteristics of the accessory 108.

Depending on the type of accessory 108 identified by the interactive apparatus 102 one or more of the following steps 706, 708 are initiated. At optional step 706, power is provided to the accessory 108 by the interactive apparatus 102 over the communication ports 110, 114. The power may be utilized to operate one or more of the output devices 202, the input devices 204 and CPU 206 of the accessory 108. Power provided to the output devices 202 may be used to produce movement, audio, visual or communication signals by the accessory 108. The output devices 202 may operate in response to an input signal provided by one or more of the input devices 204 and CPU 206 of the accessory 108, and/or by a signal provided by the interactive apparatus 102. It is also contemplated that the output devices 202 may operate in response to an input signal provided by another interactive apparatus or accessory not physically coupled to the accessory 108. When power is provided to the accessory 108 through the communication ports 110, 114, the USB device controller 422 of the interactive apparatus 102 is disabled.

At optional step 708, communication is established to the accessory 108 by the interactive apparatus 102 over the communication ports 110, 114. The communication may be established over both pairs of pins 404, 414 and 406, 416, or over as single pair of the pins 404, 414 and 406, 416. In one embodiment, the interactive apparatus 102 communicates with the accessory to provide input signals that control and/or modify the operation of the output devices 202 of the accessory 108. In another embodiment, the interactive apparatus 102 communicates with the accessory 108 to provide and/or modify computer code residing in the memory 208 of the accessory 108 that controls and/or modify the operation of the accessory 108. In another embodiment, the accessory 108 communicates with the interactive apparatus 102 to provide event information regarding the operation of the accessory 108 and/or provide information residing in the memory 208 of the accessory 108 to the interactive apparatus 102. In yet another embodiment, the interactive apparatus 102 communicates with the accessory 108 to modify the contents of the memory 208 of the accessory 108 such that the operation of the accessory 108 changes in response to the modification.

In one embodiment, the accessory 108 of a first interactive apparatus 102 may interact with an accessory of a second interactive apparatus and/or the second interactive apparatus itself. Information regarding the interaction may be communicated between the accessory 108 and the first interactive apparatus 102 to facilitate engaging in an activity, such as a game, with the second interactive apparatus. For example, the accessory 108 of the first interactive apparatus 102 may be a light cannon which generates an output signal, which when received by an input device of the accessory coupled to the second interactive apparatus or the second interactive apparatus itself, would indicate a hit or strike in the event information of both the first and second interactive apparatuses, and trigger a response to one or both of first and second interactive apparatuses, and/or one or both of the accessory coupled to first and second interactive apparatuses. For example, a hit on the second apparatus by the accessory of the first apparatus may trigger the first or second apparatus to generate an audible or visual signal.

At optional step 710, the accessory 108 is removed from the communication port 110 and the interactive apparatus 102 is coupled to the interactive application 104. While coupled, the interactive apparatus 102 and the interactive application 104 may transfer and/or exchange information using a standard USB protocol. For example, information obtained from the accessory 108 may be provided to the interactive application 104 such that virtual avatars of the accessory 108 and interactive apparatus 102 may reply the user's interactive experience with the accessory 108 and the interactive apparatus 102 in the virtual world of the interactive application 104. Likewise, information relating to the avatar of the accessory 108 in the interactive application 104 may be provided to the accessory 108 through the interactive apparatus 102 once the interactive apparatus 102 is reconnected to the accessory 108.

Thus, an interactive apparatus and method above described is thus able to discern between an accessory and/or USB host connected to the communication port of the interactive apparatus. For USB hosts, the USB hosts and the interactive apparatus are able to communicate over a standard USB or other suitable protocol. For accessories, the interactive apparatus is able to categorize the specific type of accessory connected thereto, supply power to the accessory, and/or communicate with the accessory over a simple communication interface using a communication protocol different from the standard USB protocol. Although described in the context of a game system, the invention contemplates that the communication protocol described above may allow an integrated device configured with the circuitry described with reference to the interactive apparatus to automatically configure itself as a master or slave USB device by being able to automatically identify if an object coupled to its USB port should be recognized as a master or slave USB device relative to the intelligent device.

As one skilled in the art will appreciate, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be used. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ Ruby, Python or the like and conventional procedural programming languages, such as the “C” programming language or similar programming languages, or in low-level computer language or assembly code. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN, WWAN, 3G, 4G or other) or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the foregoing is directed to embodiments of the present invention, other and further embodiments of the invention may be devised without departing from the basic scope thereof, and the scope thereof is determined by the claims that follow.

1. A system comprising:
an accessory having a communication port;
an apparatus having a communication port operable to mate with the communication port of the accessory, the interactive apparatus is operable to identify a type of accessory coupled to the communication port of the interactive apparatus.

2. The system of claim 1, wherein the apparatus is a consumer electronics device.

3. The system of claim 2, wherein the consumer electronics device is a robot, toy, a vehicle, an aircraft, a play set, a doll, or a board game.

4. The system of claim 1, wherein the accessory comprises:
a memory configured to store one or more event records representing user interactions with the accessory.

5. The system of claim 1, wherein the wherein the accessory comprises:
one or more output devices.

6. The system of claim 5, wherein the one or more output devices is at least one of a sound generating device, a light generating device, an actuator, or external communication signal generator.

7. The system of claim 1, wherein the accessory comprises:
at least one or more input devices or a predefined resistance associated with a unique type of accessory.

6-14. (canceled)

15. A method of providing interactive experience with a game system, the method comprising:
mating communication ports of an interactive apparatus and an accessory in a male/female relationship; and
identifying a unique type of accessory coupled to the interactive apparatus through a physical characteristic of the accessory.

16. The method of claim 15 comprising:
providing power to the accessory from the interactive apparatus over the communication ports.

17. The method of claim 15 comprising:
establishing communication between the accessory and the interactive apparatus over the communication ports.

18. The method of claim 15 comprising:
proving power to the accessory from the interactive apparatus over a first pair of pins; and
establishing communication between the accessory and the interactive apparatus over a second pair of pins, wherein a first pin of each pair of pins is part of the communication port of the accessory and a second pin of each pair of pins is part of the communication port of the interactive apparatus.

19. The method of claim 15 comprising:
removing the accessory from the communication port of interactive apparatus;
coupling the interactive apparatus to a host computer, wherein the interactive apparatus functions as a UBS slave relative to the host computer.

20. The method of claim 15, wherein identifying comprising:
disabling a USB device controller within the interactive apparatus in response to identifying the accessory.

21. The system of claim 5, wherein the one or more input devices is at least one of a signal generating device.

22. The system of claim 21, wherein the signal generating device is a button, a switch, a sensor, a gyroscope, an accelerometer, a proximity-sensor, a light sensor, an infrared sensor or a wireless connectivity sensor.

23. The system of claim 5, wherein the one or more input devices is a radio frequency (RF) sensor enabling peer-to-peer communication with at least one of a second accessory or a second interactive apparatus.

24. The system of claim 1, wherein the accessory is configured to modify operation in response to a signal provided by the apparatus.

25. The system of claim 1, wherein the apparatus is able to operate as a USB slave device when a USB host is coupled to the communication port of the interactive apparatus.

26. The system of claim 1, wherein the communication port of the apparatus essentially consists of 4 communication pins.

27. The system of claim 1, wherein the accessory belongs to a first type of a plurality of accessory types uniquely identifiable by the apparatus.

28. The system of claim 1, wherein the accessory types are uniquely identifiable by a predefined resistance measurable across two pins of the communication port of the accessory.
